(19) United States
(12) Patent Application Publication
(10) Pub. No.: US 2015/0300811 A1
(43) Pub. Date: Oct. 22, 2015

(54) APPARATUS FOR MEASURING INNER DIAMETER

(71) Applicant: SAMSUNG ELECTRO-MECHANICS CO., LTD., Suwon-Si (KR)

(72) Inventors: Nak Hyun SEONG, Suwon-Si (KR); Min Jung KIM, Suwon-Si (KR); Jae Youn JEONG, Suwon-Si (KR)

(21) Appl. No.: 14/335,516

(22) Filed: Jul. 18, 2014

(30) Foreign Application Priority Data
Apr. 21, 2014 (KR) 10-2014-0047623

(51) Int. Cl. G01B 11/12

(52) U.S. Cl. CPC G01B 11/12

(57) ABSTRACT

There is provided an apparatus for measuring an inner diameter, the apparatus including: an optical unit irradiating light to an object to be measured, and receiving the light therefrom; a measurement auxiliary member inserted into the object to improve measurement precision; and a calculating unit calculating an inner diameter of the object by interference between light reflected and received from an inner peripheral surface of the object and light reflected and received from an outer peripheral surface of the measurement auxiliary member.

### CROSS-REFERENCE TO RELATED APPLICATION

This application claims the benefit of Korean Patent Application No. 10-2014-0047623 filed on Apr. 21, 2014, with the Korean Intellectual Property Office, the disclosure of which is incorporated herein by reference.

### BACKGROUND

The present disclosure relates to an apparatus for measuring an inner diameter.

In general, a subminiature product is required to have high precision in components which are assembled in the product. Therefore, it is also necessary to measure a size of the manufactured component accurately.

Meanwhile, an inner diameter of a cylindrical structure is generally measured by bring a probe into contact with a surface of an object to be measured. In addition, in order to measure the overall inner diameter profile of the cylindrical structure, the measurement is performed while the probe is vertically moved.

Particularly, the inner diameter is measured by a two-contact method and a linear voltage differential transducer (LVDT) method as currently widely used methods.

The LVDT method, a method of converting mechanical displacement into electrical signals, uses a scheme of generating an electrical output in proportion to a displacement of the probe, and the two-contact method is a method in which a metal or a ceramic sphere similar to an object to be measured is inserted into a hollow and an amount of pressure applied to the sphere is measured to thereby calculate an inner diameter of the object to be measured.

However, since the contact type measurement method may cause scratches on a contact surface, precise measurement may be impossible, thereby decreasing iterative precision.

Further, since the two-contact measurement method has a limitation in accurately measuring a center of a cylinder, it has a low degree of measurement accuracy.

### RELATED ART DOCUMENT

(Patent Document 1) Korean Patent Laid-Open Publication No. 2011-0134977

### SUMMARY

An aspect of the present disclosure may provide an apparatus for measuring an inner diameter, capable of improving measurement precision.

According to an aspect of the present disclosure, an apparatus for measuring an inner diameter may include: an optical unit irradiating light to an object to be measured, and receiving the light therefrom; a measurement auxiliary member inserted into the object to improve measurement precision; and a calculating unit calculating an inner diameter of the object by interference between light reflected and received from an inner peripheral surface of the object and light reflected and received from an outer peripheral surface of the measurement auxiliary member.

The optical unit may include an optical probe irradiating and receiving the light and a lens connected to the optical probe and changing a light path.

The optical unit may further include an optical transmitter transmitting the light and an optical coupler disposed between the optical transmitter and the optical probe to distribute or synthesize the light.

The lens may have a hemispherical shape to emit the light incident into an inner surface of the object.

The calculating unit may include a spectrometer to which the light received in the optical unit is transferred.

The measurement auxiliary member may have an outer diameter formed to be smaller than an inner diameter of the object to be measured.

The measurement auxiliary member may have a cylindrical shape.

The optical unit may include an optical probe connected to the calculating unit and irradiating and receiving the light, and a reflective member inserted into a hollow of the measurement auxiliary member and changing a path of light emitted from the optical probe and incident into the reflective member.

The reflective member may be mounted on a fixing member formed on an installation member in which the object to be measured is fixedly installed.

According to another aspect of the present disclosure, an apparatus for measuring an inner diameter may include: an optical unit irradiating light to an object to be measured, and receiving the light therefrom; a measurement auxiliary member inserted into the object to improve measurement precision; and a calculating unit calculating an inner diameter of the object by interference between light reflected and received from an inner peripheral surface of the object and light reflected and received from an outer peripheral surface of the measurement auxiliary member, wherein the measurement auxiliary member has an outer diameter formed to be smaller than an inner diameter of the object, and the optical unit includes: an optical probe connected to the calculating unit and irradiating and receiving the light; a lens connected to the optical probe and changing a light path; an optical transmitter transmitting the light to the optical probe; and an optical coupler disposed between the optical transmitter and the optical probe to distribute or synthesize the light.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a configuration view illustrating an apparatus for measuring an inner diameter according to an exemplary embodiment of the present disclosure;

FIG. 2 is a schematic perspective view illustrating a measurement auxiliary member and an optical unit included in the apparatus for measuring an inner diameter according to an exemplary embodiment of the present disclosure;

FIG. 3 is a view describing an operation of the apparatus for measuring the inner diameter according to an exemplary embodiment of the present disclosure;

FIG. 4 is a configuration view illustrating an apparatus for measuring an inner diameter according to another exemplary embodiment of the present disclosure; and

FIG. 5 is a view describing an operation of the apparatus for measuring an inner diameter according to another exemplary embodiment of the present disclosure.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein.

Rather, these embodiments are provided so that this disclosure will be thorough and complete, and will fully convey the scope of the disclosure to those skilled in the art. In the drawings, the shapes and dimensions of elements may be exaggerated for clarity, and the same reference numerals will be used throughout to designate the same or like elements.

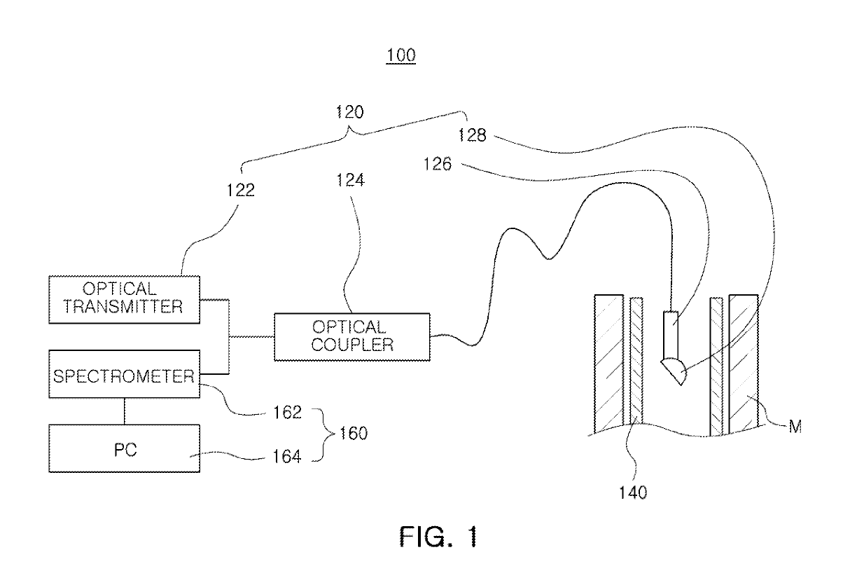

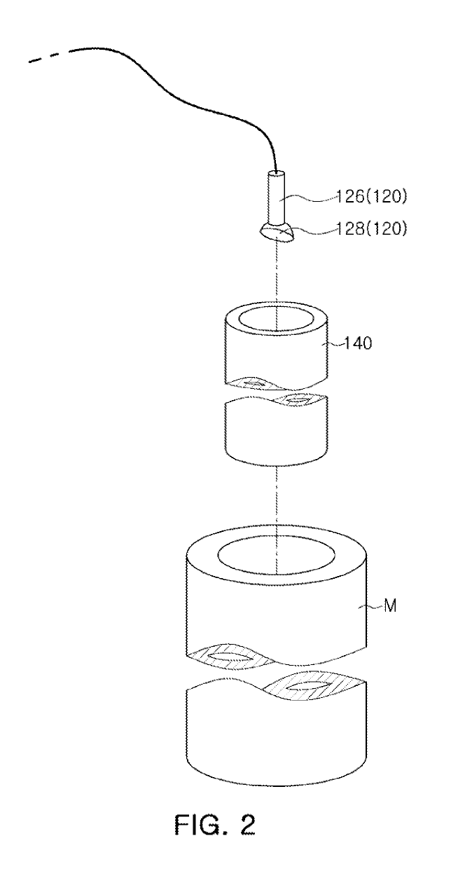

FIG. 1 is a configuration view illustrating an apparatus for measuring an inner diameter according to an exemplary embodiment of the present disclosure and FIG. 2 is a schematic perspective view illustrating a measurement auxiliary member and an optical unit included in an apparatus for measuring an inner diameter according to an exemplary embodiment of the present disclosure.

Referring to FIGS. 1 and 2, an apparatus 100 for measuring an inner diameter according to an exemplary embodiment of the present disclosure may include an optical unit 120, a measurement auxiliary member 140, and a calculating unit 160, by way of example.

Meanwhile, although not shown in the drawings, the apparatus 100 for measuring the inner diameter may be installed in an equipment body (not shown).

The optical unit 120 may irradiate light onto an object to be measured and receive the light therefrom. To this end, the optical unit 120 may include an optical transmitter 122, an optical coupler 124, an optical probe 126, and a lens 128.

The optical transmitter 122 may be a light source for a sensor and may transmit semiconductor laser having an appropriate output. As an example, the light source transmitted from the optical transmitter 122 may be broadband laser light. However, the optical transmitter 122 is not limited thereto. For example, in the optical transmitter 122, a light source such as a light emitting diode rather than the laser may be used.

The optical coupler 124 may be connected to the optical transmitter 122 through an optical fiber and serve to branch or couple optical signals from the optical fiber. That is, the optical coupler 124 may be disposed between the optical transmitter 122 and the optical probe 126 to serve to distribute or synthesize light.

In other words, the optical coupler 124 may serve to distribute light transmitted from the optical transmitter 122 to the optical probe 126 and distribute the light received in the optical probe 126 to the calculating unit 160.

Meanwhile, the optical probe 126 may irradiate the light transmitted from the optical transmitter 122 to an object M to be measured and receive the light reflected therefrom. To this end, although not shown in the drawings, the optical probe 126 may include an irradiating part and a receiving part. In other words, the optical probe 126 may serve to irradiate light and at the same time, receive the light reflected from the object M to be measured (hereinafter, referred to as “object M”).

Meanwhile, the optical probe 126 may have a size sufficient to allow the insertion thereof into a hollow of the measurement auxiliary member 140. In other words, the optical probe 126 may have a size allowing the optical probe 126 to be inserted into the hollow of the measurement auxiliary member 140 so that the optical probe 126 may irradiate light to an inner surface of the object M in a state in which the optical probe 126 is inserted into the hollow of the measurement auxiliary member 140.

In addition, the optical probe 126 and the optical coupler 124 may also be connected to each other by the optical fiber.

The lens 128 may be connected to the optical probe 126 to change a light path. That is, the lens 128 may change the light path in such a manner that light irradiated from the optical probe 126 may be irradiated to the object M and may change the light path in such a manner that received light may be incident into the optical probe 126.

Meanwhile, the lens 128 may have a hemispherical shape, but is not limited thereto. For example, the lens 128 may have any shape as long as the light irradiated and received from the optical probe 126 may be irradiated to the object M and then, be received in the optical probe 126.

The measurement auxiliary member 140 may be inserted into the object M to serve to improve measurement precision. Meanwhile, the measurement auxiliary member 140 may have a shape corresponding to the object M. As an example, each of the measurement auxiliary member 140 and the object M may have a cylindrical shape having a hollow and the measurement auxiliary member 140 may have a size allowing for the insertion thereof into the hollow of the object M.

Meanwhile, the measurement auxiliary member 140 may have an outer diameter formed to be smaller than an inner diameter of the object M. As a result, in the case in which the measurement auxiliary member 140 is inserted into the hollow of the object M, an outer peripheral surface of the measurement auxiliary member 140 may be disposed to be spaced apart from an inner peripheral surface of the object M by a predetermined distance.

Consequently, the measurement auxiliary member 140 may serve as a circle of reference to more precisely measure the inner diameter of the object M.

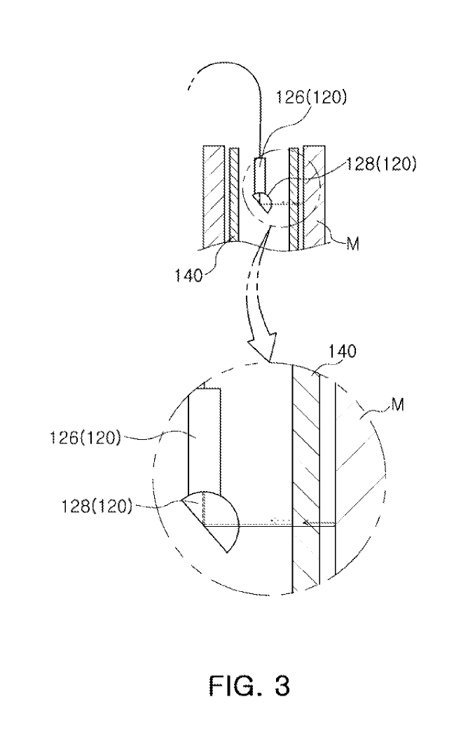

Meanwhile, operations capable of improving measurement precision using the measurement auxiliary member 140 will be described with reference to FIG. 3. As shown in FIG. 3, the measurement auxiliary member 140 may be disposed to be inserted into the hollow of the object M. In this case, the outer peripheral surface of the measurement auxiliary member 140 and the inner peripheral surface of the object M may be spaced apart from each other by a predetermined distance.

In this state, the optical probe 126 of the optical unit 120 may be inserted into the hollow of the measurement auxiliary member 140.

Then, a path of light irradiated by the optical probe 126 may be changed by the lens 128 and the light may be irradiated to the measurement auxiliary member 140.

A portion of the light irradiated to the measurement auxiliary member 140 may be reflected from the outer peripheral surface of the measurement auxiliary member 140 and then, be incident into the optical probe 126 via the lens 128, and a remaining portion thereof may be reflected from the inner peripheral surface of the object M and then, be incident into the optical probe 126 via the lens 128.

As such, as a path of the light irradiated to the measurement auxiliary member 140 is changed, light interference may be caused. A gap between the outer peripheral surface of the measurement auxiliary member 140 and the inner peripheral surface of the object M may be calculated using the light interference.

As compared to a non-contact type inner diameter measurement method in which the measurement auxiliary member 140 is not used, since the inner diameter of the object M may be measured by measuring a relatively short distance using the measurement auxiliary member 140, errors in measurement may be decreased.

The calculating unit 160 may calculate the inner diameter of the object M by interference between light reflected and received from the inner peripheral surface of the object M and light reflected and received from the outer peripheral surface of the measurement auxiliary member 140.

Meanwhile, the calculating unit 160 may include a spectrometer 162 to which the light received in the optical unit 120 is transmitted, and a PC 164 connected to the spectrometer 162 and calculating the inner diameter of the object M using the light interference.

Here, an operation of the apparatus for measuring the inner diameter according to an exemplary embodiment of the present disclosure will be described.

First, light is transmitted from the optical transmitter 122. The light transmitted from the optical transmitter 122 may be transferred to the optical coupler 124 through the optical fiber. In addition, the light may be transmitted from the optical coupler 124 to the optical probe 126 through the optical fiber.

Then, the path of light irradiated by the optical probe 126 may be changed to the object M by the lens 128 and the light may be irradiated to the object M.

A portion of the light irradiated to the object M may be reflected from the outer peripheral surface of the measurement auxiliary member 140 and a remaining portion thereof may be reflected from the inner peripheral surface of the object M and then, be incident into the lens 128.

A path of light reflected from the object M and the measurement auxiliary member 140 may be changed by the lens 128, and the light may be incident into the optical probe 126.

The light incident into the optical probe 126 may be transmitted to the optical coupler 124 through the optical fiber. The optical coupler 124 may divide and distribute the incident light and the light transmitted from the optical transmitter 122. Consequently, the light transmitted to the optical coupler 124 may be transferred to the calculating unit 160.

Then, the light incident into the spectrometer 162 may be divided into a spectrum by the spectrometer 162 and information on the spectrum may be transferred to the PC 164.

The PC 164 may calculate the inner diameter of the object M based on the information.

As described above, since the distance to be calculated may be shortened by the measurement auxiliary member 140, errors in the measurement may be decreased. That is, the inner diameter may be more precisely measured by the measurement auxiliary member 140.

Hereinafter, another exemplary embodiment of the present disclosure will be described with reference to the accompanying drawings. However, a detail description of components the same as the above-mentioned components will be replaced by the above description and be omitted below.

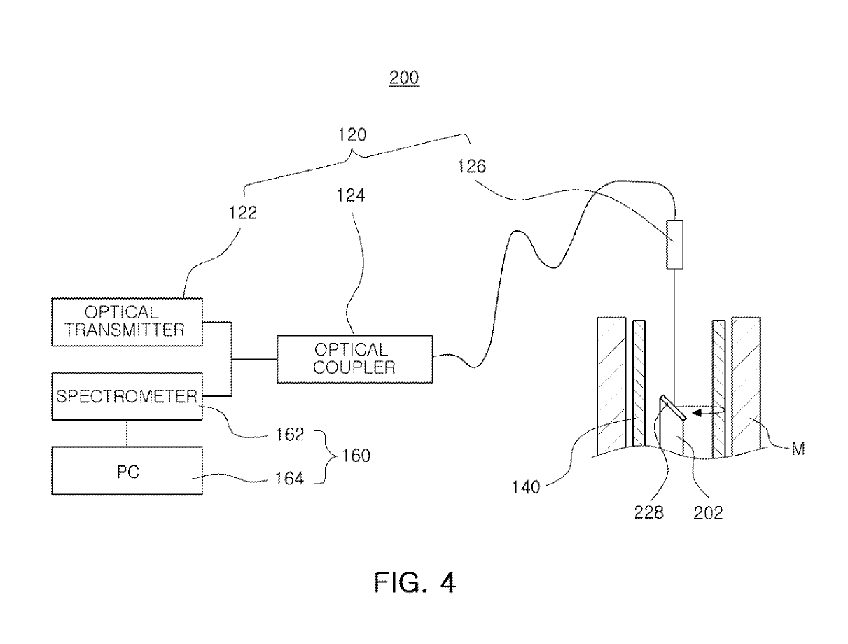

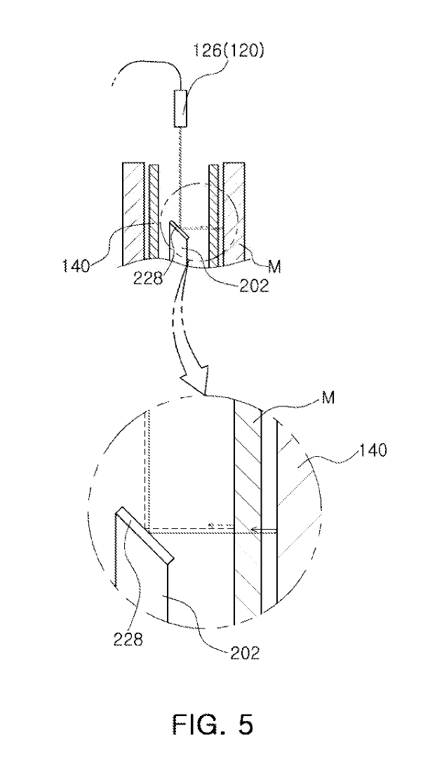

FIG. 4 is a configuration view illustrating an apparatus for measuring an inner diameter according to another exemplary embodiment of the present disclosure and FIG. 5 is a view describing an operation of the apparatus for measuring an inner diameter according to another exemplary embodiment of the present disclosure.

Referring to FIGS. 4 and 5, an apparatus 200 for measuring an inner diameter according to another exemplary embodiment of the present disclosure may include the optical unit 120, the measurement auxiliary member 140, and the calculating unit 160.

The optical unit 120 may irradiate light to an object M to be measured (hereinafter, referred to as “object M”) and receive the light therefrom. To this end, the optical unit 120 may include the optical transmitter 122, the optical coupler 124, the optical probe 126, and a reflective member 228.

Meanwhile, since the optical transmitter 122, the optical coupler 124, and the optical probe 126 of the optical unit 120 are the same components as those described above, they will be denoted by the same reference numerals as those described above and a detailed description thereof will be omitted.

The optical probe 126 may be disposed above a hollow formed in the measurement auxiliary member 140 and the object M and may irradiate the light to the hollow of the measurement auxiliary member 140.

In addition, the reflective member 228 may be mounted on a fixing member 202 formed on an installation member (not shown) in which the object M is fixedly installed. That is, the reflective member 228 may be inserted into the hollow of the measurement auxiliary member 140 and change a path of light emitted from the optical probe 126 and incident thereinto.

As such, a small inner diameter of the object M may also be measured by installing the reflective member 228 on the fixing member 202. In other words, in the case of the object M having an inner diameter to a degree, such that the optical probe 126 may not be inserted into a hollow of the object M, the inner diameter of the object M may also be measured by installing the reflective member 228 on the fixing member 202.

Hereinafter, an operation of the apparatus 200 for measuring an inner diameter according to another exemplary embodiment of the present disclosure will be described.

First, light is transmitted from the optical transmitter 122. The light transmitted from the optical transmitter 122 may be transferred to the optical coupler 124 through the optical fiber. In addition, the light may be transmitted from the optical coupler 124 to the optical probe 126 through the optical fiber.

Then, the path of light irradiated by the optical probe 126 may be changed to the object M by the reflective member 228 and the light may be irradiated to the object M.

A portion of the irradiated light may be reflected from the outer peripheral surface of the measurement auxiliary member 140 and a remaining portion thereof may be reflected from the inner peripheral surface of the object M and then, be incident into the reflective member 228.

Then, a path of light reflected from the object M and the measurement auxiliary member 140 may be changed by the reflective member 228 and the light may be incident into the optical probe 126.

Meanwhile, operations capable of improving measurement precision using the measurement auxiliary member 140 will be described with reference to FIG. 5. As shown in FIG. 5, the measurement auxiliary member 140 may be inserted into the hollow of the object M. In this case, the outer peripheral surface of the measurement auxiliary member 140 and the inner peripheral surface of the object M may be spaced apart from each other by a predetermined distance.

In this state, the optical probe 126 of the optical unit 120 may be disposed above the measurement auxiliary member 140 and the reflective member 228 may be inserted into the hollow of the measurement auxiliary member 140.

Then, the path of light irradiated by the optical probe 126 may be changed by the reflective member 228 and the light may be irradiated to the measurement auxiliary member 140 side.

A portion of the light irradiated to the measurement auxiliary member 140 may be reflected from the outer peripheral surface of the measurement auxiliary member 140 and then, be incident into the optical probe 126 via the reflective member 228, and a remaining portion thereof may be reflected from the inner peripheral surface of the object M and then, be incident into the optical probe 126 via the reflective member 228.

As such, as the path of light irradiated to the measurement auxiliary member 140 is changed, light interference may be caused.

The light incident into the optical probe 126 may be then transmitted to the optical coupler 124 through the optical fiber. The optical coupler 124 may divide and distribute the incident light and the light transmitted from the optical transmitter 122. Consequently, the light transmitted to the optical coupler 124 may be transferred to the calculating unit 160.

Then, the light incident into the spectrometer 162 may be divided into spectrum by the spectrometer 162 and information on the spectrum may be transferred to the PC 164.

The PC 164 may calculate the inner diameter of the object M based on the information.

As described above, since the distance to be calculated may be shortened by the measurement auxiliary member 140, errors in the measurement may be decreased. That is, the inner diameter may be more precisely measured by the measurement auxiliary member 140.

As set forth above, according to exemplary embodiments of the present disclosure, measurement precision may be improved by a measurement auxiliary member.

While exemplary embodiments have been shown and described above, it will be apparent to those skilled in the art that modifications and variations could be made without departing from the spirit and scope of the present disclosure as defined by the appended claims.

What is claimed is:

1. An apparatus for measuring an inner diameter, the apparatus comprising:
an optical unit irradiating light to an object to be measured, and receiving the light therefrom;
a measurement auxiliary member inserted into the object to improve measurement precision; and
a calculating unit calculating an inner diameter of the object by interference between light reflected and received from an inner peripheral surface of the object and light reflected and received from an outer peripheral surface of the measurement auxiliary member.

2. The apparatus for measuring an inner diameter of claim 1, wherein the optical unit includes an optical probe irradiating and receiving the light and a lens connected to the optical probe and changing a light path.

3. The apparatus for measuring an inner diameter of claim 2, wherein the optical unit further includes an optical transmitter transmitting the light and an optical coupler disposed between the optical transmitter and the optical probe to distribute or synthesize the light.

4. The apparatus for measuring an inner diameter of claim 2, wherein the lens has a hemispherical shape to emit the light incident into an inner surface of the object.

5. The apparatus for measuring an inner diameter of claim 2, wherein the calculating unit includes a spectrometer to which the light received in the optical unit is transferred.

6. The apparatus for measuring an inner diameter of claim 1, wherein the measurement auxiliary member has an outer diameter formed to be smaller than an inner diameter of the object.

7. The apparatus for measuring an inner diameter of claim 6, wherein the measurement auxiliary member has a cylindrical shape.

8. The apparatus for measuring an inner diameter of claim 1, wherein the optical unit includes an optical probe connected to the calculating unit and irradiating and receiving the light, and a reflective member inserted into a hollow of the measurement auxiliary member and changing a path of light emitted from the optical probe and incident into the reflective member.

9. The apparatus for measuring an inner diameter of claim 8, wherein the reflective member is mounted on a fixing member formed on an installation member in which the object to be measured is fixedly installed.

10. An apparatus for measuring an inner diameter, the apparatus comprising:
an optical unit irradiating light to an object to be measured, and receiving the light therefrom;
a measurement auxiliary member inserted into the object to improve measurement precision; and
a calculating unit calculating an inner diameter of the object by interference between light reflected and received from an inner peripheral surface of the object and light reflected and received from an outer peripheral surface of the measurement auxiliary member,
wherein the measurement auxiliary member has an outer diameter formed to be smaller than an inner diameter of the object, and
the optical unit includes:
an optical probe connected to the calculating unit and irradiating and receiving the light;
a lens connected to the optical probe and changing a light path;
an optical transmitter transmitting the light to the optical probe; and
an optical coupler disposed between the optical transmitter and the optical probe to distribute or synthesize the light.
